(19) United States
(12) Patent Application Publication
(10) Pub. No.: US 2019/0027304 A1
(43) Pub. Date: Jan. 24, 2019

(54) REACTOR

(71) Applicants: AUTONETWORKS TECHNOLOGIES, LTD., Yokkaichi-shi, Mie (JP); SUMITOMO WIRING SYSTEMS, LIMITED, Yokkaichi-shi, Mie (JP); SUMITOMO ELECTRIC INDUSTRIES, LTD., Osaka-shi, Osaka (JP)

(72) Inventors: Takashi MISAKI, Yokkaichi (JP); Kazuhiro INABA, Yokkaichi (JP)

(73) Assignees: AUTONETWORKS TECHNOLOGIES, LTD., Yokkaichi-shi, Mie (JP); SUMITOMO WIRING SYSTEMS, LIMITED, Yokkaichi-shi, Mie (JP); SUMITOMO ELECTRIC INDUSTRIES, LTD., Osaka-shi, Osaka (JP)

(21) Appl. No.: 16/069,456

(22) PCT Filed: Jan. 11, 2017
(86) PCT No.: PCT/JP2017/000677

§ 371 Date: Jul. 11, 2018

(30) Foreign Application Priority Data
Jan. 22, 2016 (JP) 2016-011112

(51) Int. Cl. H01F 27/40; H01F 27/28; H01F 27/24; H01F 41/02; H01F 41/06; G01K 1/14

(52) U.S. Cl. CPC H01F 27/402; H01F 27/2823; H01F 27/24; H01F 2027/406; H01F 41/06; G01K 1/14; H01F 41/0246

(57) ABSTRACT

A reactor that includes an assembly that includes a coil with a pair of winding portions that are arranged side by side, and a magnetic core; a sensor that acquires information regarding a physical value related to the reactor and outputs the information to an external device, and a sensor holder for fixing the sensor to the assembly, wherein the sensor holder is a member that is separate from the assembly.

This application is the U.S. National Phase of PCT/JP2017/000677 filed Jan. 11, 2017, which claims priority to Japanese Patent Application No. 2016-011112 filed on Jan. 22, 2016, the entire contents of which are incorporated herein by reference.

### BACKGROUND

The present disclosure relates to a reactor.

JP 2013-128084A discloses a reactor including an assembly obtained by combining a coil that has a pair of winding portions and a magnetic core, a part of which is arranged inside the winding portions, and a sensor (typically, a temperature sensor) that acquires information regarding a physical value related to the reactor and outputs the information to an external device. The sensor includes a sensor main body that detects a physical value, a wiring portion extending from the sensor main body, and a connector portion for electrically connecting the sensor main body to an external device. According to the reactor of JP 2013-128084A, the sensor main body is fixed in a space between the pair of winding portions by the sensor holder, and the connector portion is fixed to a casing for accommodating the assembly. Since the connector portion is fixed to the casing, it is easy to connect the connector portion and the external device to each other.

### SUMMARY

An aspect of the present disclosure is directed to a reactor including an assembly that includes a coil with a pair of winding portions that are arranged side by side, and a magnetic core; a sensor that acquires information regarding a physical value related to the reactor and outputs the information to an external device, wherein the sensor includes: a sensor main body that detects the physical value, a wiring extending from the sensor main body, and a connector provided at an end of the wiring; and a sensor holder for fixing the sensor to the assembly, wherein the sensor holder is a member that is separate from the assembly, and the sensor holder includes: a holder main body, a part of which is arranged between the pair of winding portions, a main body holder provided in the holder main body at a portion thereof positioned between the pair of winding portions, the main body holder holding the sensor main body, and a connector holder provided in the holder main body at a portion thereof positioned above the pair of winding portions, the connector holder holding the connector.

### BRIEF DESCRIPTION OF THE DRAWINGS

FIG. 1 is a schematic perspective view of a reactor shown in Embodiment 1.

FIG. 2 is an exploded perspective view of the reactor shown in Embodiment 1.

FIG. 3 is a schematic vertical cross-sectional view of the reactor shown in Embodiment 1.

FIG. 4 is an explanatory view showing assembling of a sensor and a sensor holder included in the reactor shown in Embodiment 1.

FIG. 5 is a partially enlarged view of a connector portion of the sensor and a connector holding portion of the sensor holder of FIG. 4.

### DETAILED DESCRIPTION OF EMBODIMENTS

Recent development of electric motor vehicles has lead to a need to make reactors more compact. For example, research has been conducted on configurations and the like in which a casing dedicated to a reactor is omitted and an assembly is accommodated in a converter casing for accommodating a switching element and an inverter. Furthermore, the configurations are not limited to those in which an assembly is accommodated in a converter casing, and configurations in which an assembly is accommodated in a gap between devices included in an electric motor vehicle are also conceivable. In such configurations, cases may arise in which there is almost no installation space for a connector portion on a side of an assembly (on an outer side of an assembly when viewed from above), and the connector portion cannot be fixed.

Thus, an exemplary aspect of the disclosure provides a reactor in which a connector portion of a sensor can be fixed to an assembly even when there is almost no installation space for the connector portion on a side of the assembly.

According to a reactor of the present disclosure, a connector portion of a sensor can be fixed to the assembly even when there is almost no installation space for the connector portion on a side of an assembly.

First, embodiments of the present disclosure will be listed and described.

During in-depth research conducted on the above-described problems, the inventors of the present disclosure focused on the fact that there is often relatively enough room for an installation space above an assembly. Thus, a configuration in which both a sensor main body and a connector portion are fixed to a sensor holder was arrived at, and a reactor according to an embodiment was completed. In the description below, the reactor according to the embodiment will be stipulated.

<1> An embodiment is directed to a reactor including: an assembly that includes a coil with a pair of winding portions that are arranged side by side, and a magnetic core; a sensor that acquires information regarding a physical value related to the reactor and outputs the information to an external device, wherein the sensor includes: a sensor main body that detects the physical value, a wiring extending from the sensor main body, and a connector provided at an end of the wiring; and a sensor holder for fixing the sensor to the assembly, wherein the sensor holder is a member that is separate from the assembly, and the sensor holder includes: a holder main body, a part of which is arranged between the pair of winding portions, a main body holder provided in the holder main body at a portion thereof positioned between the pair of winding portions, the main body holder holding the sensor main body, and a connector holder provided in the holder main body at a portion thereof positioned above the pair of winding portions, the connector holder holding the connector.

In the reactor of this embodiment, the connector portion (connector) is held above the pair of winding portions, and thus the connector portion can be positioned inside the outer peripheral contour of the assembly when the assembly is viewed from above. That is to say, it is possible to fix the connector portion to the assembly without any issue even in the case where there is no installation space for the connector portion on an outer side of the reactor (on a side of the assembly) when the assembly is viewed from above.

Furthermore, according to the reactor of this embodiment, it is possible to shorten the length of the wiring portion (wiring) connecting the sensor main body and the connector portion, and to prevent the wiring portion from being bent in a complex manner. As a result, it is possible to reduce measurement noise in the sensor.

<2> The reactor according to an embodiment may be such that the sensor is a temperature sensor.

The temperature of the assembly (in particular, the coil) of the reactor is likely to reach high temperatures when in use, and, when the temperature of the assembly is too high, the assembly may be damaged. Thus, as shown in the above-described configuration, it is preferable that a temperature sensor is arranged between a pair of winding portions and is used to monitor the temperature of the assembly, thereby controlling the amount of electricity that is applied to the assembly such that the assembly is not damaged.

<3> The reactor according to an embodiment may be such that the connector holding portion (connector holder) and the connector portion respectively include engagement structures that engage with each other.

If a pair of engagement structures that engage with each other are provided, it is possible to effectively prevent the connector portion attached to the connector holding portion from coming loose. As the engagement structures, structures that engage with each other at their claws can be used.

<4> The reactor according to an embodiment may be such that the reactor further includes an adhesive member (adhesive) for bonding the part of the holder main body arranged between the pair of winding portions, to the winding portions.

If an adhesive member is provided, it is possible to fix the position of the sensor main body between the pair of winding portions. Furthermore, if an adhesive member is provided, the distance between the winding portions and the sensor main body can be fixed, and thus measurement results by the sensor can be stabilized. Note that the sensor main body may be in close contact with the winding portions, or may be slightly spaced apart from the winding portions.

<5> The reactor according to an embodiment may be such that the reactor further includes a dislodgement preventing portion (dislodgement preventer) provided in the holder main body at a portion thereof positioned between the pair of winding portions, the dislodgement preventing portion suppressing dislodgement of the sensor holder from the assembly by engaging with a part of the assembly.

If the holder main body of the sensor holder is provided with a dislodgement preventing portion, the sensor holder can be prevented from coming loose from the position between the pair of winding portions. The dislodgement preventing portion may be formed in the shape of a claw, for example. If the claw-like dislodgement preventing portion engages with, for example, a step portion arranged on outer resin-molded portions (which will be described in the embodiment) in the magnetic core of the assembly, dislodgement of the sensor holder from the assembly can be suppressed.

### DETAILS OF EMBODIMENTS OF THE PRESENT DISCLOSURE

Hereinafter, embodiments of the reactor according to the present disclosure will be described with reference to the drawings. Constituent elements with the same names are denoted by the same reference numerals in the drawings.

### Embodiment 1

### Overall Configuration

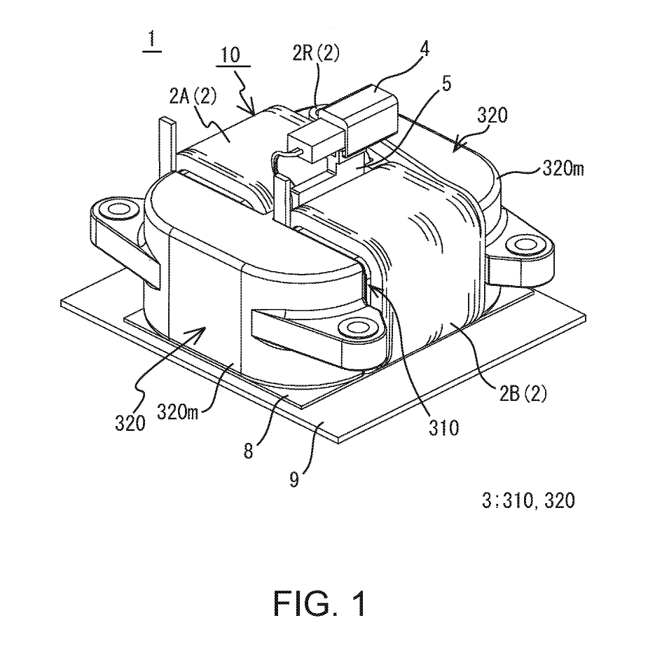

A reactor 1 shown in FIG. 1 has a configuration in which an assembly 10 including a coil 2 and a magnetic core 3 is fixed via a joint layer 8 to a mount plate 9. The reactor 1 of this example further includes a sensor 4 that acquires information regarding a physical value related to the reactor 1 and outputs the information to an external device, and a sensor holder 5 for fixing the sensor 4 to the assembly 10. The main difference between the reactor 1 of this example and a conventional reactor is the configuration of the sensor holder 5. Hereinafter, aspects of the configuration of the reactor 1 will be described in detail.

### Assembly

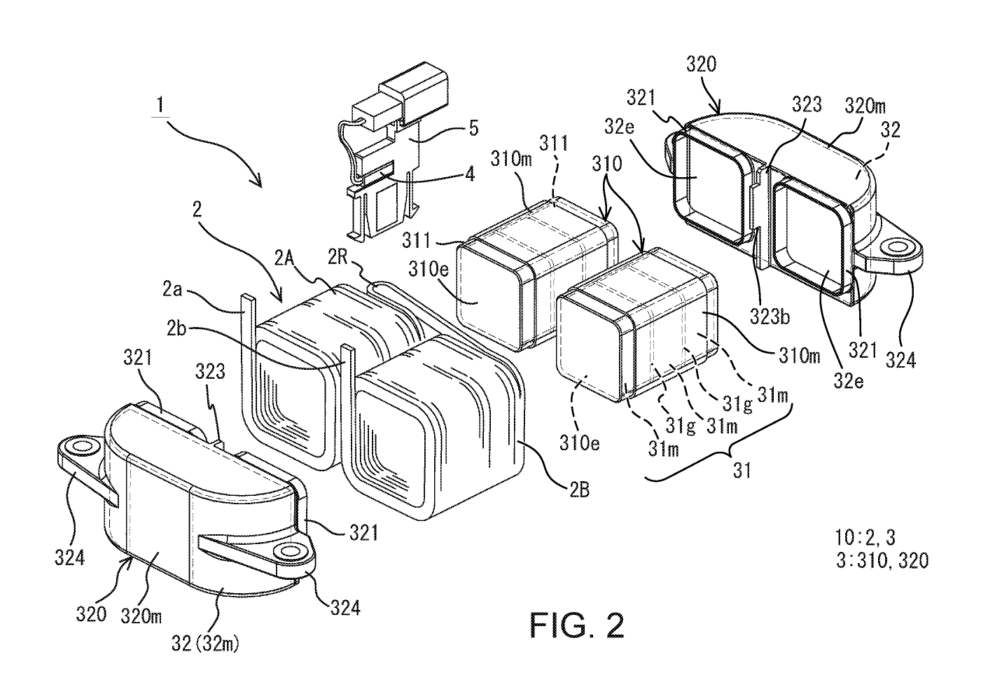

The assembly 10 obtained by mechanically combining the coil 2 and the magnetic core 3 will be described mainly with reference to the exploded perspective view in FIG. 2.

### Coil

The coil 2 in this embodiment includes a pair of winding portions 2A and 2B, and a connection portion 2R for connecting the two winding portions 2A and 2B. The winding portions 2A and 2B each have a hollow tubular shape in the same winding direction with the same number of turns, and are arranged side by side such that their axial directions are parallel with each other. Also, the connection portion 2R is bent in a U-shape connecting the two winding portions 2A and 2B. This coil 2 may also be formed by helically winding one winding wire with no joint portion, or may also be formed by producing the winding portions 2A and 2B using separate winding wires and joining ends of the winding wires of the winding portions 2A and 2B through welding or crimping, for example.

The winding portions 2A and 2B of this embodiment each have a rectangular tubular shape. The winding portions 2A and 2B with a rectangular tubular shape are winding portions whose end surfaces have a shape obtained by rounding the corners of a rectangle (which may be a square). It will be appreciated that the winding portions 2A and 2B may also each have a circular tubular shape. Winding portions with a circular tubular shape are winding portions whose end surfaces are in the shape of a closed surface (elliptical shape, perfectly circular shape, race track shape, etc.).

The coil 2 including the winding portions 2A and 2B is constituted by a coated wire including an insulating coating made of an insulating material on the outer periphery of a conductor such as a flat wire or a round wire made of a conductive material such as copper, aluminum, magnesium, or alloys thereof. In this embodiment, the winding portions 2A and 2B are formed by edgewise winding a coated flat wire in which a conductor is constituted by a copper flat wire and an insulating coating is made of an enamel (typically, polyamide imide).

Two ends 2a and 2b of the coil 2 respectively extend from the winding portions 2A and 2B, and are connected to a terminal member (not shown). An external apparatus such as a power source for supplying power to the coil 2 is connected via this terminal member.

### Magnetic Core

There is no particular limitation on the configuration of the magnetic core 3. The magnetic core 3 of this example includes a pair of first split cores 310 that are formed into a column shape, and a pair of second split cores 320 that connect end surfaces 310e of the first split cores 310. The first split cores 310 and the second split cores 320 are connected to each other in a ring shape, thereby forming the magnetic core 3. Note that the split state of the magnetic core 3 is not limited to the state in FIG. 2, and, for example, the magnetic core 3 may be formed also by combining two schematically U-shaped split cores.

### First Split Cores

Each of the first split cores 310 of this example is a member including an inner core portion 31 that is arranged inside the winding portion 2A (2B) of the coil 2 and a resin-molded portion 310m that covers the outer periphery of the inner core portion 31. The inner core portion 31 is constituted by a plurality of core pieces 31m and a plurality of gap materials 31g that are alternately stacked. The core pieces 31m may be constituted by powder compacts that are obtained by compression molding a raw material powder containing a soft magnetic powder made of iron-group metals such as iron or an alloy thereof (an Fe—Si alloy, an Fe—Ni alloy, etc.). That is to say, each of the first split cores 310 is a core component in which a plurality of powder compacts (the core pieces 31m) are integrated by the resin-molded portion 310m. The gap materials 31g are members for adjusting the magnetic characteristics of the inner core portion 31, and may be made of, for example, alumina or the like.

Examples of the resin for forming the resin-molded portions 310m include thermoplastic resins such as a polyphenylenesulfide (PPS) resin, a polytetrafluoroethylene (PTFE) resin, a liquid crystal polymer (LCP), a polyamide (PA) resin such as Nylon 6 or Nylon 66, a polybutylene terephthalate (PBT) resin, and an acrylonitrile-butadiene-styrene (ABS) resin. Other examples of the resin include thermosetting resins such as an unsaturated polyester resin, an epoxy resin, a urethane resin, and a silicone resin. It is also possible to improve the heat dissipation properties of the resin-molded portions 310m by mixing a ceramic filler such as alumina, silica, or the like into these resins.

Note that the first split cores 310 may be made of a composite material obtained by dispersing a soft magnetic powder in a resin. The resin for the composite material may be the same resin as that for the resin-molded portions 310m described above.

### Second Split Cores

Each of the second split cores 320 of this example is a member in which the outer periphery of a corresponding outer core portion 32, which is arranged outside the winding portions 2A and 2B, is covered with a resin-molded portion 320m. The outer core portions 32 are each constituted by a core piece 32m, which is a substantially semi-cylindrical shaped powder compact. The resin for forming the resin-molded portions 320m may be the same resin as that for the resin-molded portions 310m of the first split cores 310.

The second split cores 320 also may be made of a composite material. Note that one of the first split cores 310 and the second split cores 320 may be made of a composite material, and the other may be made of a resin-molded powder compact.

### Other Configurations Regarding Core Component

The first split cores 310 and the second split cores 320 of this example are connected to each other by mechanically fitting thin-walled portions 311 that are formed at axial ends of the first split cores 310 to frame portions 321 that are formed in the second split cores 320. The thin-walled portions 311 are portions formed by making the resin-molded portions 310m thinner than the other portions, and the frame portions 321 are portions formed by making the resin-molded portions 320m project in a tubular shape. Inside the frame portions 321, the outer core portions 32 are exposed without being covered with the resin-molded portions 320m.

In the configuration of this example in which the first split cores 310 and the second split cores 320 are connected to each other, the end surfaces 310e of the first split cores 310 come into contact with end surfaces 32e of the outer core portions 32 (the core pieces 32m) of the second split cores 320. An adhesive may also be used to join the end surfaces 310e and the end surfaces 32e. Here, the end surfaces 310e are constituted by the resin-molded portions 310m that cover end surfaces of the inner core portions 31. Thus, in this example, the resin-molded portions 310m function as gap materials between the end surfaces of the inner core portions 31 and the end surfaces 32e of the outer core portions 32.

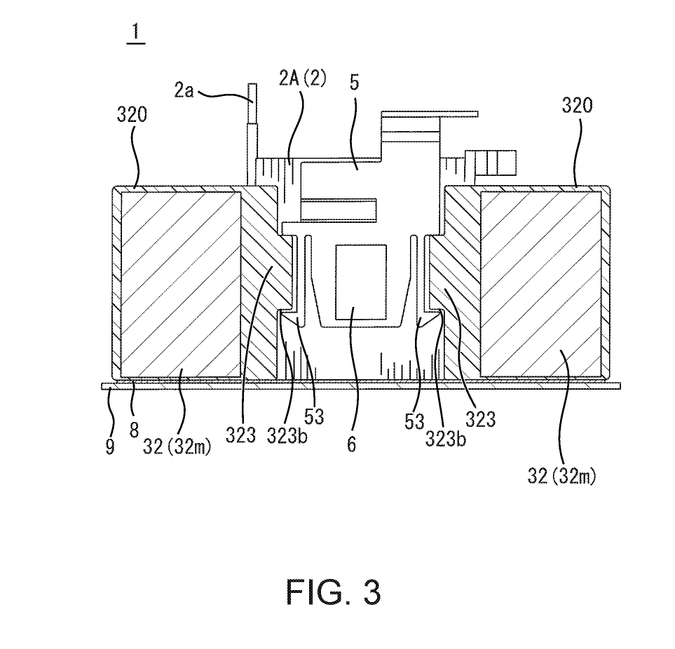

Furthermore, each of the second split cores 320 of this example is provided with a partitioning portion 323 arranged between the pair of winding portions 2A and 2B. The partitioning portion 323 can ensure insulation between the two winding portions 2A and 2B. In the partitioning portion 323, a portion that is slightly above the middle protrudes more than the other portions, and step portions 323b are formed between the protruding portion and the non-protruding portions. As described later with reference to FIG. 3, the sensor holder 5 engages with the step portions 323b.

Furthermore, the second split cores 320 of this example include fixing portions 324 for fixing the assembly 10 to an unshown converter casing or the like. One fixing portion 324 is provided on one end side and the other end side in the width direction (the direction in which the winding portions 2A and 2B are arranged side by side) of each second split core 320. In this example, the fixing portions 324 are formed by embedding collars made of highly rigid metal or resin in the resin-molded portions 320m.

### Sensor

The sensor 4 is a member that acquires information regarding a physical value related to the reactor 1 and outputs the information to an external device.

Examples of the physical value include a temperature of the reactor 1 in accordance with the application of electricity, acceleration that is an indicator of the vibration level, and the like. The sensor 4 of this example is a temperature sensor.

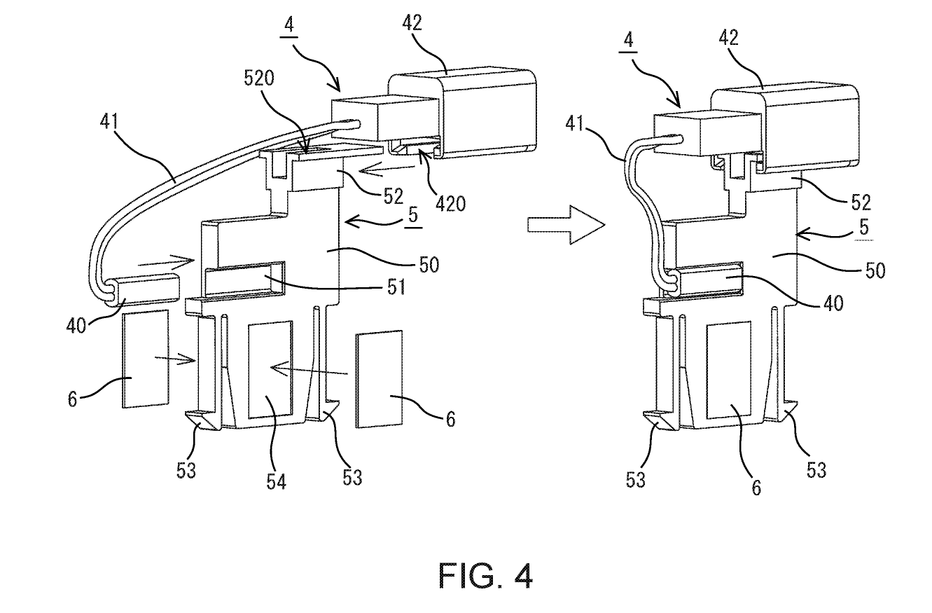

As shown in FIG. 4, the sensor 4 includes a sensor main body 40 that has an element that actually detects the temperature, a wiring portion 41 extending from the sensor main body 40, and a connector portion 42 provided at an end of the wiring portion 41. The sensor main body 40 of the sensor 4 may have a known configuration, for example, in which an element is covered with resin.

The wiring portion 41 may have a known configuration, for example, in which a wire for transmitting a measurement result from the sensor main body 40 is covered with resin. Note that the wiring portion 41 of this example is considerably shorter than a wiring portion of a sensor used for a reactor with a conventional configuration. The reason for this is that, as described later, the wiring portion 41 does not have to be long because both the sensor main body 40 and the connector portion 42 are fixed to the sensor holder 5.

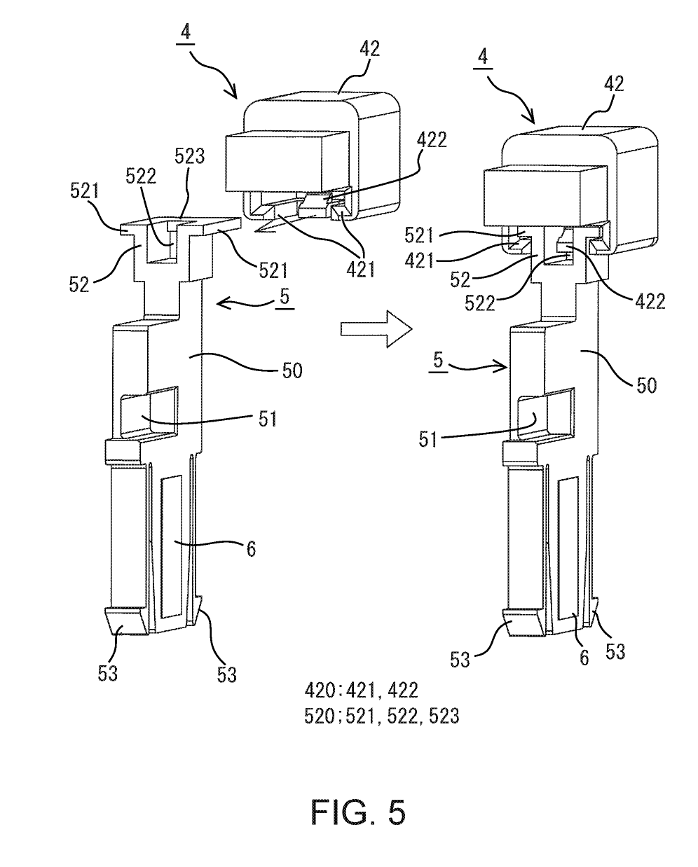

The connector portion 42 is a connecting member for electrically connecting the sensor main body 40 to an external device. The connector portion 42 of this example includes a connector-side engagement structure 420 that engages with a later-described connector holding portion 52 of the sensor holder 5. Hereinafter, the configuration of the connector-side engagement structure 420 will be described in detail with reference to FIG. 5. As shown in the left portion in FIG. 5, the connector-side engagement structure 420 includes slide rail portions 421 and a claw portion 422. The slide rail portions 421 are formed by making both side faces of the housing of the connector portion 42 extend downward, and bending the ends of the extending portions inward. The inner sides of opening-side ends (on the front side in the section of the diagram) of the slide rail portions 421 are tapered. The claw portion 422 is formed by making an end of a rod-like member extending from the inner side of the slide rail portions 421 toward the opening side protrude upward in the section of the diagram.

### Sensor Holder

As shown in FIG. 4, the sensor holder 5 includes a holder main body 50 made of an insulating material such as a PPS resin. The sensor holder 5 can be formed through injection molding or the like.

The middle of the holder main body 50 is provided with a main body holding portion 51 (main body holder) constituted by a rectangular recess formed by locally reducing the thickness. The sensor main body 40 of the sensor 4 is fitted to the main body holding portion 51. The depth, the width, and the length of the main body holding portion 51 are substantially the same as the thickness in the depth direction in the section of the diagram, the width in the upper-lower direction in the section of the diagram, and the length of the sensor main body 40, and thus the sensor main body 40 perfectly fits the main body holding portion 51. It will be appreciated that the dimensions of the sensor main body 40 do not have to completely match the dimensions of the main body holding portion 51, and, for example, it is also possible that the thickness of the sensor main body 40 is larger than the depth of the main body holding portion 51. With this configuration, the sensor main body 40 protrudes from the holder main body 50, and thus the sensor main body 40 can be brought into contact with the winding portion 2B (FIG. 1, etc.).

The upper end of the holder main body 50 is provided with the connector holding portion 52 formed in the shape of a rail. The connector holding portion 52 includes a holder-side engagement structure 520 that engages with the connector-side engagement structure 420 of the sensor 4. Hereinafter, the configuration of the holderside engagement structure 520 will be described in detail with reference to FIG. 5. As shown in the left portion in FIG. 5, the holderside engagement structure 520 includes protruding portions 521 protruding in the thickness direction of the holder main body 50 and a hole portion 522 into which the claw portion 422 of the connector-side engagement structure 420 is inserted. The protruding portions 521 are connected to a connection piece 523 on the fitting side of the connector portion 42. The thus configured connector holding portion 52 includes a recessed face that is open to the opposite side of the connector portion 42 when viewed from above, a frame-like face that surrounds the hole portion 522 when viewed from the fitting side of the connector portion 42, and a recessed face that is open upward when viewed from the side opposite to the fitting side of the connector portion 42. When the connector portion 42 is slid over and fitted into the connector holding portion 52, as shown in the right portion in FIG. 5, the slide rail portions 421 engage with the protruding portions 521, and the claw portion 422 is inserted into the hole portion 522 and engages with the connection piece 523. As a result, it is possible to prevent the connector portion 42 attached to the connector holding portion 52 from coming loose.

As shown in FIG. 4, the portion of the holder main body 50 below the main body holding portion 51 is formed in the shape of a plate with a narrowed end, and both sides of the plate-like portion are provided with dislodgement preventing portions 53. The dislodgement preventing portions 53 are each constituted by a rod-like member extending downward from the middle of the holder main body 50, and claw-shaped members in which an end of the rod-like member protrudes in directions away from the plate-like portion. As shown in the vertical cross-sectional view in FIG. 3, the claw-shaped members of the dislodgement preventing portions 53 are caught on the step portions 323b of the partitioning portions 323 of the second split cores 320 when the sensor holder 5 is arranged on the assembly 10. As a result, dislodgement of the sensor holder 5 from the assembly 10 is suppressed.

The plate-like portion of the holder main body 50 is provided with a recess portion 54. A face of the plate-like portion facing rearward in the section of the diagram is also provided with a recess portion 54. The recess portions 54 are provided with adhesive sheets (adhesive members) 6. The adhesive sheets 6 are for fixing the holder main body 50 to the winding portions 2A and 2B (FIG. 1, etc.). Since the adhesive sheets 6 are provided, the distance between the winding portions 2A and 2B and the sensor main body 40 can be fixed, and thus measurement results by the sensor 4 can be stabilized.

The adhesive sheets 6 are preferably made of a foamable resin. The thickness of the adhesive sheets 6 is preferably approximately (depth of the recess portions 54)+1 mm or less, and particularly preferably the depth of the recess portions 54 or less. When the thickness of the adhesive sheets 6 is set to such a thickness, it is easy to insert the holder main body 50 into a space between the winding portions 2A and 2B. If the foamable resin is caused to foam after the holder main body 50 has been inserted into a space between the winding portions 2A and 2B, the holder main body 50 can be bonded to the winding portions 2A and 2B.

It will be appreciated that the adhesive sheets 6 are not limited to a foamable resin, and may merely be an adhesive sheet material. In that case, a configuration is possible in which the adhesive sheets 6 that are thicker than the depth of the recess portions 54 are bonded to the recess portions 54, the space between the winding portions 2A and 2B is increased, and then the space between the winding portions 2A and 2B is reduced in a state where the holder main body 50 is interposed between the winding portions 2A and 2B. In addition, a configuration is also possible in which the plate-like portion of the holder main body 50 is not provided with the recess portions 54, and adhesive sheet materials are bonded to or an adhesive (adhesive members) is applied to the plate-like portion. Also in this case, the holder main body 50 may be interposed between the winding portions 2A and 2B with the space therebetween increased.

### Other Aspects of Configuration

As shown in FIG. 1, the reactor 1 of Embodiment 1 includes the mount plate 9, the joint layer 8, and the like.

### Mount Plate

The mount plate 9 is a member that functions as a base when the reactor 1 is fixed to an installation target such as a cooling base. Thus, the mount plate 9 is required to have excellent mechanical strength. Furthermore, the mount plate 9 is required to serve to release heat generated in the assembly 10 while the reactor 1 is in use to the installation target. Thus, the mount plate 9 is required to have excellent heat dissipation properties in addition to mechanical strength. In order to meet these requirements, the mount plate 9 is made of metal. For example, aluminum and alloys thereof and magnesium and alloys thereof can be used as the material for forming the mount plate 9. These metals (alloys) have advantages of being excellent in terms of mechanical strength and thermal conductivity, lightweight, and non-magnetic.

### Joint Layer

The joint layer 8 is formed between the mount plate 9 and the assembly 10 described above, the joint layer 8 joining the mount plate 9 and the assembly 10. The joint layer 8 also has the function of conducting heat generated in the assembly 10 while the reactor 1 is in use to the mount plate 9.

A material that has insulating properties is used as the material for forming the joint layer 8. Examples thereof include thermosetting resins such as epoxy resins, silicone resins, and unsaturated polyesters and thermoplastic resins such as PPS resins and LCPs. It is also possible to improve the heat dissipation properties of the joint layer 8 by mixing the above-described ceramic filler or the like into these insulating resins. The joint layer 8 has a thermal conductivity of, for example, preferably 0.1 W/m·K or more, more preferably 1 W/m·K or more, and particularly preferably 2 W/m·K or more.

The joint layer 8 may be formed by applying an insulating resin (which may be a resin containing a ceramic filler) onto the mount plate 9, or may be formed by bonding a sheet material made of an insulating resin onto the mount plate 9. The use of a sheet-like material as the joint layer 8 is preferable because this makes it easy to form the joint layer 8 on the mount plate 9.

### Effects of Reactor

In the reactor 1 of this embodiment, the connector portion 42 of the sensor 4 is held above the pair of winding portions 2A and 2B, and thus the connector portion 42 can be positioned inside the outer peripheral contour of the assembly 10 when the assembly 10 is viewed from above. That is to say, it is possible to fix the connector portion 42 to the assembly 10 without any issue even in the case where there is no installation space for the connector portion 42 on an outer side of the reactor 1 (on a side of the assembly 10) when the assembly 10 is viewed from above.

Furthermore, according to the reactor 1 of this embodiment, it is possible to shorten the length of the wiring portion 41 connecting the sensor main body 40 and the connector portion 42, and to prevent the wiring portion 41 from being bent in a complex manner. As a result, it is possible to reduce measurement noise in the sensor 4.

### Embodiment 2

As already described in the description of Embodiment 1, the configuration of the magnetic core included in the reactor is not limited to the configuration in Embodiment 1. For example, as in the reactor of Patent Document 1, the magnetic core may be formed by combining core pieces whose outer peripheries are not covered with a resin-molded portion. In that case, it is preferable to use insulating interposed members for ensuring insulation between the magnetic core and the coil.

The insulating interposed members are divided into inner portion interposed members and end surface interposed members. The inner portion interposed members are interposed between the inner peripheral faces of the coil and the magnetic core, and insulate between the coil and the magnetic core. The end surface interposed members are interposed between end surfaces of the coil and outer core portions of the magnetic core, and insulate between the coil and the magnetic core.

The combination of the sensor 4 and the sensor holder 5 in FIG. 4 can be arranged also in an assembly including a magnetic core obtained by combining the above-described core pieces and insulating interposed members. In the case of this configuration, it is preferable that partitioning portions similar to the partitioning portions 323 shown in FIG. 2 are provided on the end surface interposed members. If partitioning portions are provided on the end surface interposed members, dislodgement of the sensor holder 5 from the assembly can be suppressed.

### Applications

The reactor of the present disclosure can be used in power conversion apparatuses such as a two-way DC-DC converter that is to be mounted in an electric motor vehicle such as a hybrid car, an electric automobile, or a fuel-cell vehicle.

1. A reactor comprising:
an assembly that includes a coil with a pair of winding portions that are arranged side by side, and a magnetic core;
a sensor that acquires information regarding a physical value related to the reactor and outputs the information to an external device, wherein the sensor includes:
a sensor main body that detects the physical value,
a wiring extending from the sensor main body, and
a connector provided at an end of the wiring; and
a sensor holder for fixing the sensor to the assembly, wherein the sensor holder is a member that is separate from the assembly, and the sensor holder includes:
a holder main body, a part of which is arranged between the pair of winding portions,
a main body holder provided in the holder main body at a portion thereof positioned between the pair of winding portions, the main body holder holding the sensor main body, and
a connector holder provided in the holder main body at a portion thereof positioned above the pair of winding portions, the connector holder holding the connector.

2. The reactor according to claim 1, wherein the sensor is a temperature sensor.

3. The reactor according to claim 1, wherein the connector holder and the connector respectively include engagement structures that engage with each other.

4. The reactor according to claim 1, further comprising an adhesive for bonding the part of the holder main body arranged between the pair of winding portions, to the winding portions.

5. The reactor according to claim 1, further comprising a dislodgement preventer provided in the holder main body at a portion thereof positioned between the pair of winding portions, the dislodgement preventer suppressing dislodgement of the sensor holder from the assembly by engaging with a part of the assembly.
